(19) United States
(12) Patent Application Publication
(10) Pub. No.: US 2021/0373219 A1
(43) Pub. Date: Dec. 2, 2021

(54) FLEXIBLE POLARIZING COVER BOARD, MANUFACTURING METHOD THEREOF, AND FLEXIBLE DISPLAY DEVICE

(71) Applicant: Wuhan China Star Optoelectronics Semiconductor Display Technology Co., Ltd., Wuhan (CN)

(72) Inventor: Chao ZHU, Wuhan (CN)

(73) Assignee: Wuhan China Star Optoelectronics Semiconductor Display Technology Co., Ltd., Wuhan (CN)

(21) Appl. No.: 16/634,151

(22) PCT Filed: Oct. 22, 2019
(86) PCT No.: PCT/CN2019/112565

§ 371 Date: Jan. 26, 2020

(30) Foreign Application Priority Data
Jul. 26, 2019 (CN) 201910683250.2

(51) Int. Cl. G02B 5/30; G02B 1/14

(52) U.S. Cl. CPC G02B 5/3033; G02B 5/3016; G02B 1/14

(57) ABSTRACT

A flexible polarizing cover board, a manufacturing method thereof, and a flexible display device are provided. A polarizer is integrated with a cover board to reduce a thickness of the flexible display device. A silicon dioxide protective layer is disposed at a non-bending region of the flexible polarizing cover board, and a stress buffer layer and a water blocking layer are disposed at a bending region, thus achieving flexible bending of the polarizer at the bending region and protection by a high-strength hardened thin film at the non-bending region. Furthermore, the flexible polarizing cover board is also provided with a liquid crystal layer to enhance optical characteristics of the flexible polarizing cover board.

### FIELD OF INVENTION

The application relates to the field of optical technology, and in particular, to a flexible polarizing cover board, a manufacturing method thereof, and a flexible display device.

### BACKGROUND OF INVENTION

With the rapid development of flexible display devices, higher requirements are put on foldable properties of polarizers, requesting not only flexibility of the polarizers but also their surface hardness.

Currently, the polarizer and a protective cover board are independently adhered on a display screen of the flexible display device to form a complete touch display device. In order to realize flexibility, strength of a non-bending region is reduced and the protective cover board is required for bonding on the surface of the polarizer by optically transparent gel. However, this results in an increased thickness of the touch display device, and is disadvantageous to a bending characteristic of the flexible display device.

Therefore, it is necessary to provide a flexible polarizing cover board to solve technical problems that polarizers in the prior art have lower strength at non-bending regions, and bonding the protective cover board on the surface of the polarizer increases thickness of the flexible display device.

### SUMMARY OF INVENTION

A purpose of the application is to provide a flexible polarizing cover board, a manufacturing method thereof, and a flexible display device, so that technical problems, which are polarizers in the prior art with lower strength at non-bending regions and increasing of a thickness of a flexible display device caused by bonding a protective cover board on a surface of a polarizer, can be solved.

To solve the above problems, an embodiment of the application provides a flexible polarizing cover board including a polarizing layer and a cover board layer configured to bond to each other. The flexible polarizing cover board has a bending region and a non-bending region. The cover board layer is provided with a composite film layer at a position corresponding to the bending region and a hardened thin film at a position corresponding to the non-bending region; wherein the composite film layer includes a stress buffer layer and a water blocking layer located on a surface of the stress buffer layer.

Here, a thickness of the stress buffer layer is greater than a thickness of the water blocking layer.

Here, material of the stress buffer layer is anti-bending transparent material.

Moreover, edges of the composite film layer extend beyond a boundary line between the bending region and the non-bending region to an interior of the non-bending region.

Moreover, on adjacent edges of the composite film layer and the hardened thin film, a junction edge of the composite film layer is provided with a plurality of openings, a junction edge of the hardened thin film is provided with a plurality of protrusions individually corresponding to the openings, and each of the protrusions is embedded in its corresponding opening.

Furthermore, the bending region is disposed at a middle or one side of the flexible polarizing cover board.

Furthermore, the polarizing layer includes a first polarizing layer including a liquid crystal layer, and a second polarizing layer including a polyvinyl alcohol film.

To solve the above problems, an embodiment of the application also provides a manufacturing method of a flexible polarizing cover board including following steps:

a step 1 of manufacturing a liquid crystal layer and a polyvinyl alcohol film located on a surface of the liquid crystal layer to form a polarizing layer;

a step 2 of manufacturing a hardened thin film on a surface of a non-bending region of the polarizing layer; and

a step 3 of manufacturing a stress buffer layer and a water blocking layer, which is located on a surface of the stress buffer layer, on a surface of a bending region of the polarizing layer.

According to the above purpose of the application, it further provides a flexible display device. The flexible display device includes a display panel; a touch layer located above the display panel; and a flexible polarizing cover board located above the touch layer. The flexible polarizing cover board includes a polarizing layer and a cover board layer configured to bond to each other, and the flexible polarizing cover board has a bending region and a non-bending region. The cover board layer is provided with a composite film layer at a position corresponding to the bending region and a hardened thin film at a position corresponding to the non-bending region; wherein the composite film layer includes a stress buffer layer and a water blocking layer located on a surface of the stress buffer layer. The polarizing layer includes a first polarizing layer including a liquid crystal layer, and a second polarizing layer including a polyvinyl alcohol film.

Furthermore, a thickness of the first polarizing layer is one-fourth of a light-emitting wavelength of the display panel.

### Advantageous Effects of the Application

The polarizer is integrated with the cover board to reduce a thickness of the flexible display device, thereby being beneficial for a bending property of the flexible display device. A silicon dioxide protective layer is disposed at the non-bending region of the flexible polarizing cover board, and the stress buffer layer and the water blocking layer are disposed at the bending region, thus realizing that the polarizer is bent at the bending region and has high-strength protection at the non-bending region, so that reliability of the flexible polarizing cover board is elevated. Moreover, using an inkjet printing process and a vapor deposition process makes material of the bending region be more densely filled in the bending region to relieve stresses. Furthermore, the flexible polarizing cover board is also provided with a liquid crystal layer to enhance optical characteristic of the flexible polarizing cover board.

### DESCRIPTION OF DRAWINGS

In order to more clearly illustrate technical solutions in embodiments of the application, the drawings to be used in the description of the embodiments will be briefly described below. Obviously, the drawings in the following description are only some of the embodiments of the application. For those skilled in the art, other drawings may also be obtained from these drawings without making creative effort.

FIG. 1 is a structural schematic view of a flexible polarizing cover board provided by an embodiment of the present application.

FIG. 2 is a structural schematic view of a cover board in a flexible polarizing cover board provided by an embodiment of the present application.

FIG. 3 is a structural schematic view of a second polarizing layer in a flexible polarizing cover board provided by an embodiment of the present application.

FIG. 4 is a structural schematic view of another flexible polarizing cover board provided by an embodiment of the present application.

FIG. 5 is a schematic view of a bending structure of another flexible polarizing cover board provided by an embodiment of the present application.

FIG. 6 is a process diagram of a manufacturing method of a flexible polarizing cover board provided by an embodiment of the present application.

FIG. 7 is a structural schematic view of a flexible display device provided by an embodiment of the present application.

### DETAILED DESCRIPTION OF PREFERRED EMBODIMENTS

The application will be further described in detail below with reference to accompanying drawings and embodiments. It is particularly noted that the following embodiments are only used to illustrate the application, but not intended to limit the scope of the application. Similarly, the following embodiments are only some of the embodiments of the application, but not all of the embodiments of the application. All other embodiments obtained by those skilled in the art without making creative effort are within the scope of the application.

For technical problems that polarizers in the prior art have lower strength at non-bending regions, and bonding a protective cover board on surface of the polarizer increases a thickness of a flexible display device, the embodiments of the present application can solve these deficiencies.

The present application provides a flexible polarizing cover board, including a polarizing layer and a cover board layer configured to bond to each other, wherein the flexible polarizing cover board has a bending region and a non-bending region. The cover board layer is provided with a composite film layer at a position corresponding to the bending region and a hardened thin film at a position corresponding to the non-bending region. Both the composite film layer and the hardened thin film are located on a surface of the polarizing layer. The composite film layer includes a stress buffer layer and a water blocking layer which is located on a surface of the stress buffer layer.

As shown in FIG. 1, specifically, the present application provides a flexible polarizing cover board 100, including a polarizing layer 103 and a cover board layer 106. The flexible polarizing cover board 100 has a bending region 101 and a non-bending region 102. In this embodiment, the non-bending region 102 includes a first non-bending region 1021 and a second non-bending region 1022, and the bending region 101 is located between the first non-bending region 1021 and the second non-bending region 1022. The cover board layer 106 includes a composite film layer 105 and a hardened thin film 104 interlinked with each other. The composite film layer 105 disposed in the bending region 101 includes a stress buffer layer 1051 and a water blocking layer 1052 which is located on a surface of the stress buffer layer 1051. The hardened thin film 104 includes a first hardened thin film 1041 and a second thin film 1042, which are respectively disposed in the first non-bending region 1021 and the second non-bending region 1022. Material of the first hardened thin film 1041 and the second hardened thin film 1042 both include silicon dioxide to realize the flexible polarizing cover board 100 with higher strength at the first hardened thin film 1041 and the second hardened thin film 1042, and thus the polarizing layer 103 is better protected.

The cover board layer 106 is provided with the stress buffer layer 1051 at a position corresponding to the bending region 101, and the water blocking layer 1052 is located on a surface of the stress buffer layer 1051. A thickness of the stress buffer layer 1051 is greater than a thickness of the water blocking layer 1052 to be beneficial for the flexible bending of the bending region 101.

Material of the stress buffer layer 1051 is an anti-bending transparent organic material, including one of acrylic, hexamethyldisiloxane, polyacrylate, polycarbonate, polyimide, and polystyrene, or any combination thereof, to relieve stress of a flexible display device during bending or folding, thereby reducing damage caused by excessive stress on the flexible polarizing cover board. Material of the water blocking layer 1052 is one of Al2O3, TiO2, SiNx, SiCNx, SiOx, and SiO2, or any combination thereof, thereby protecting a flexible touch layer and the polarizing layer from water vapor erosion to prolong display lifespan of the flexible display device.

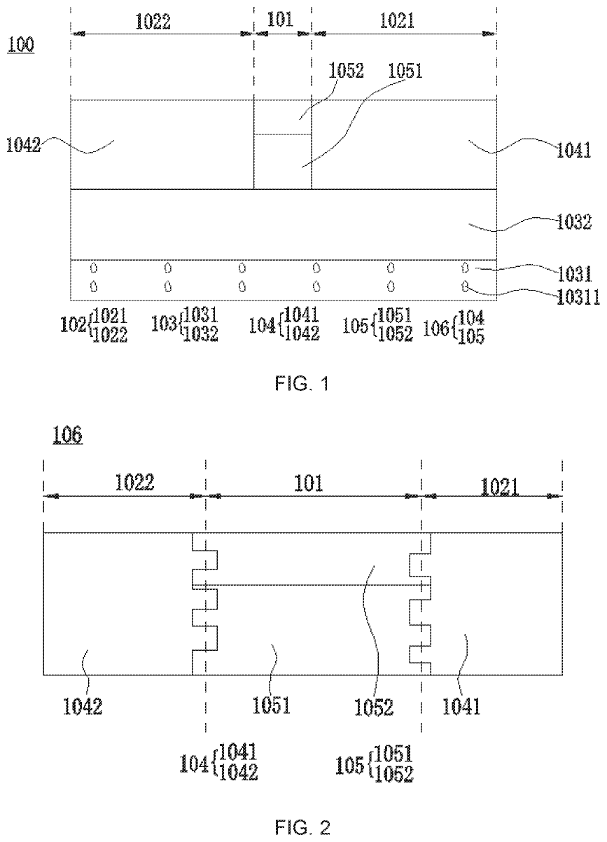

As shown in FIG. 2, this embodiment provides a structural schematic view of a cover board in a flexible polarizing cover board. In order to properly link the hardened thin film 104 and the composite film layer 105, one side edge of the composite film layer 105 extends beyond a boundary line between the bending region 101 and the first non-bending region 1021 to an interior of the first non-bending region 1021 and interlinks with the first hardened thin film 1041; another side edge of the composite film layer 105 extends beyond a boundary line between the bending region 101 and the second non-bending region 1022 to an interior of the second non-bending region 1022 and interlinks with the second hardened thin film 1042. On adjacent edges of the composite film layer 105 and the hardened thin film 104, a junction edge of the composite film layer 105 is provided with a plurality of openings, a junction edge of the hardened thin film 104 is provided with a plurality of protrusions individually corresponding to the openings, and each of the protrusions is embedded in its corresponding opening.

As shown in FIG. 1, the polarizing layer 103 modulates a polarization state of light emitted by a display panel, such that light transmitted by the polarizing layer 103 at different positions has specific polarization states that are distinguished from each other to realize stereoscopic display of light.

The polarizing layer 103 includes a first polarizing layer 1031 and a second polarizing layer 1032. The first polarizing layer 1031 is a liquid crystal layer, and the second polarizing layer 1032 includes a polyvinyl alcohol film. In this embodiment, the second polarizing layer 1032 is located on the first polarizing layer 1031.

Liquid crystal units 10311 in the polarizing layer 1031 are neatly arranged with a predetermined tilt angle. Each of the liquid crystal units 10311 can individually serve as an optical switch, and selectively allow light emitted by the display panel to pass, thereby converting light emitted by a light source into a planar matrix light source. At the same time, light passing through the liquid crystal layer would be deflected to realize light emitted at a predetermined angle, thereby generating phase retardation to obtain light having a same polarization state transition property as that of a quarter-wave plate, while preventing light from entering the second polarizing layer 1032 to be reflected.

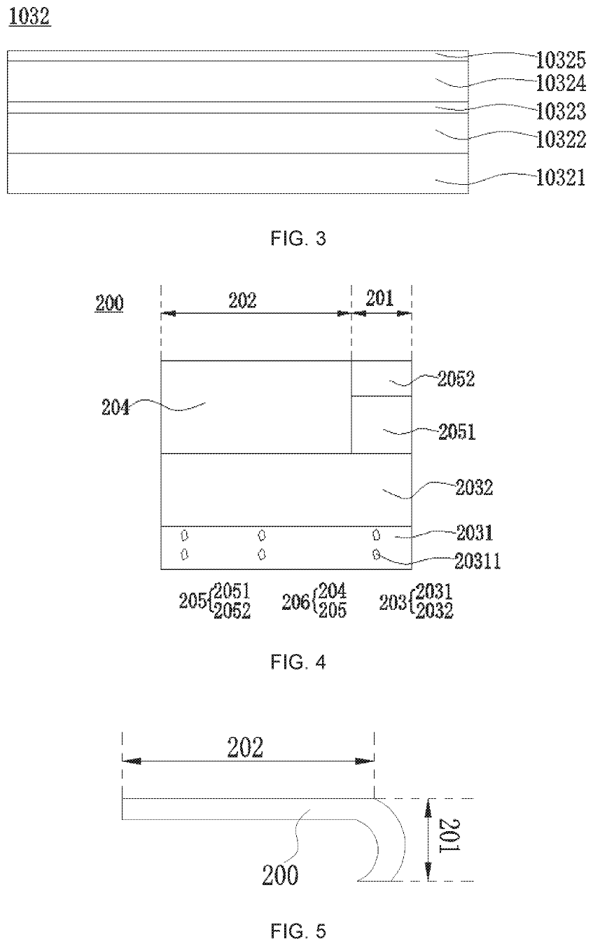

As shown in FIG. 3, the second polarizing layer 1032 includes a release film 10321, a pressure-sensitive adhesive layer 10322, and the polyvinyl alcohol film 10324, which are stacked in sequence. The pressure-sensitive adhesive layer 10322 is disposed on the release film 10321, and the polyvinyl alcohol film 10324 is disposed on the pressure-sensitive adhesive layer 10322. Both sides of the polyvinyl alcohol film 10324 are respectively provided with a first cellulose triacetate film 10323 and a second cellulose triacetate film 10325. The polyvinyl alcohol film 10324 functions as the polarizing effect; however, the polyvinyl alcohol film 10324 is easily hydrolyzed. Therefore, in order to protect a polarization physical property of the polyvinyl alcohol film 10324, both sides of the polyvinyl alcohol film 10324 are respectively bonded with the cellulose triacetate film, which has high light transmittance, good water resistance, and a certain mechanical strength, to protect the polyvinyl alcohol film 10324. The pressure-sensitive adhesive layer 10322 is made by a thermostable and moisture-proof pressure-sensitive gel, and after the polyvinyl alcohol film 10324 is treated by a special dipping process, a manufactured second polarizing layer would be a wide-temperature type polarizing layer. Components for preventing passage of ultraviolet light are added to the pressure-sensitive adhesive layer 10322 to form an anti-ultraviolet polarizing layer. A transmitted original sheet is bonded with a birefringence optical compensation film to form the polarizing layer with a twist angle of 90 to 270 degrees. A transmitted original sheet is bonded with a light redirecting film to form a polarizing layer with wide viewing angles or a polarizing layer with narrow viewing angles. The planar matrix light source passes through the second polarizing layer 1032, is deflected at a predetermined angle, and is then projected on a screen for display.

In the present application, the first polarizing layer 1031 and the second polarizing layer 1032 are disposed in the polarizing layer 103 to obtain light having a same polarization property as that of a half-wave plate or the quarter-wave plate, so that the stereoscopic display of the display device is realized without additionally providing the half-wave plate or the quarter-wave plate, and a step of accurately aligning the half-wave plate or quarter-wave plate with the liquid crystal units on a controllable matrix light source is also waived, thereby reducing production difficulty, improving product yield, and reducing production costs.

As shown in FIG. 4, the present application provides another flexible polarizing cover board 200, including a polarizing layer 203 and a cover board layer 206, and the flexible polarizing cover board 200 has a bending region 201 and a third non-bending region 202 which is located at one side of the bending region 201. In this embodiment, the polarizing layer 203 includes a first polarizing layer 2031 and a second polarizing layer 2032. The first polarizing layer 2031 includes a liquid crystal layer which is provided with a plurality of liquid crystal units 20311 in an array arrangement, and the second polarizing layer 2032 includes a polyvinyl alcohol film. The cover board layer 206 is provided with a composite film layer 205 at a position corresponding to the bending region 201 and a third hardened thin film 204 at a position corresponding to the third non-bending region 202. Both the composite film layer 205 and the third hardened thin film 204 are located on a surface of the polarizing layer 203. The composite film layer 205 includes a stress buffer layer 2051 and a water blocking layer 2052 which is located on a surface of the stress buffer layer 2051.

As shown in FIG. 5, the present application provides a schematic view of bending of the another flexible polarizing cover board 200. A thickness of the stress buffer layer 2051 is greater than a thickness of the water blocking layer 2052 to be beneficial for flexible bending of the bending region 201. A preferred range of a bending radius of the bending region 201 is 0.01 mm to 0.4 mm. The third non-bending region 202 in this embodiment rotates around the bending region 201.

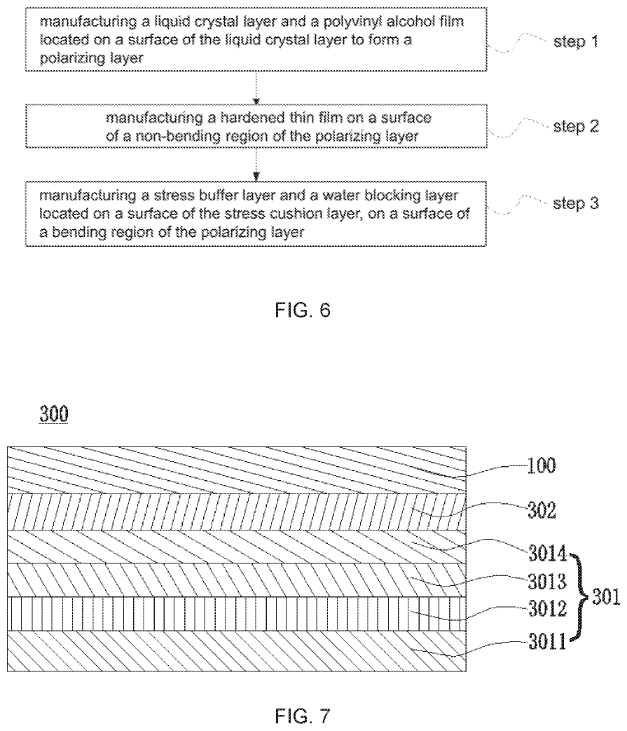

As shown in FIG. 6, according to the above flexible polarizing cover board, a manufacturing method of the flexible polarizing cover board is also provided, including the following steps:

a step 1 of manufacturing a liquid crystal layer and a polyvinyl alcohol film located on a surface of the liquid crystal layer to form a polarizing layer;

a step 2 of manufacturing a hardened thin film on a surface of a non-bending region of the polarizing layer; and

a step 3 of manufacturing a stress buffer layer and a water blocking layer which is located on a surface of the stress buffer layer, on a surface of a bending region of the polarizing layer.

Preferably, the step 2 further includes:

coating high-strength silicon dioxide on both sides of the flexible polarizing cover board at 4 mm from a bending center to form the hardened thin film with a thickness of 8 to 25 μm.

Preferably, the step 3 further includes:

inkjet printing an organic transparent polyimide material on a surface of the 8 mm bending region of the flexible polarizing cover board, and slots are filled by a leveling process and a curing process, thereby forming the stress buffer layer with a thickness of 5 to 22 μm.

Inorganic silicon nitride with a thickness of 3 to 10 μm is deposited on a surface of the stress buffer layer by chemical vapor deposition, and photolithography is performed by using a mask to form the water blocking layer.

As shown in FIG. 7, according to the above purpose of the present application, a flexible display device 300 is further provided, including:

A display panel 301 includes a flexible substrate 3011, a driving circuit layer 3012, a functional layer 3013, and a thin film encapsulation layer 3014. The flexible substrate 3011 includes a first organic layer and an inorganic layer which are stacked in sequence. The first organic layer is a whole-surface film layer, and the inorganic layer is of a patterned structure. The whole-surface film layer refers to a whole film that is uniform and seamless, and the patterned structure may be a spaced concave and convex structure. In other words, the inorganic layer includes an inorganic material layer and gaps in the middle. When the inorganic layer is deformed by bending, the gaps in the inorganic layer can release bending stress to reduce stress applied to the inorganic layer, thereby preventing the inorganic layer from being broken or stripped from the first organic layer to enhance the bendability of the flexible substrate and prolong service lifespan of the flexible substrate. The driving circuit layer 3012 located on a surface of the flexible substrate 3011 includes a buffer layer, a driving layer, and an ITO layer, which are stacked from bottom to top. The buffer layer is formed on the surface of the flexible substrate 3011, and the driving layer is formed on a surface of the buffer layer. The driving layer includes a plurality of driving thin film transistors which at least include gates, a gate insulating layer, an active layer, and a source and drain layer. The gate insulating layer is formed on a gate layer, the active layer is formed on the gate insulating layer, and the active layer is configured to be insulated from the gate layer. Both sides of the active side are provided with the source and drain layers. The source and drain layer includes sources and drains which are respectively connected electrically to corresponding positions of the active layer. The ITO layer includes pixel electrodes connected to the drains in the driving thin film transistors. The functional layer 3013 located on a surface of the driving circuit layer 3012 is a single-layer device structure, a bilayer device structure, a three-layer device structure, or multi-layer device structure. Taking the three-layer device structure as an example, the functional layer 3013 includes a hole transporting layer, an electron transporting layer, and a luminescent layer. The thin film encapsulation layer 3014 is generally an inorganic/organic/inorganic multi-layer film lamination structure, and is located on a surface of the functional layer 3013 to protect a light-emitting device in the functional layer 3013 from water vapor erosion to prolong the display lifespan of the display panel 301.

A flexible touch layer 302 is located on the flexible display panel 301.

A flexible polarizing cover board 100 located on the touch layer 302 includes a polarizing layer and a cover board layer configured to bond to each other, and the flexible polarizing cover board has a bending region and a non-bending region. The cover board layer is provided with a composite film layer at a position corresponding to the bending region and a hardened thin film at a position corresponding to the non-bending region; wherein the composite film layer includes a stress buffer layer and a water blocking layer which is located on a surface of the stress buffer layer. The polarizing layer includes a first polarizing layer including a liquid crystal layer, and a second polarizing layer including a polyvinyl alcohol film. A preferred thickness of the first polarizing layer is one-fourth of a light-emitting wavelength of the display panel.

In the present application, the polarizer is integrated with the cover board to reduce a thickness of the touch display device, thereby being conducive to a bending property of the flexible display device. The cover board is designed as a three-stage structure. Both sides of the non-bending region are provided with high-strength inorganic material silicon dioxide, and the bending region is provided with the stress buffer layer and the water blocking layer, thus realizing flexible bending while ensuring strength of the cover board, so that reliability of the flexible polarizing cover board is elevated. Moreover, using an inkjet printing process and a vapor deposition process allow material of the bending region to be filled more densely. Because the processes of the present application are simple, they can be used for industrial production.

In summary, although the application has been disclosed with preferred embodiments, the preferred embodiments don't intend to limit the application, and those of ordinary skill in the art can make various changes and modifications without departing from the spirit and the scope of the present application. Therefore, the protection of the present application is defined by the scope of the claims.

What is claimed is:

1. A flexible polarizing cover board, comprising:
a polarizing layer and a cover board layer configured to bond to each other;
the flexible polarizing cover board has a bending region and a non-bending region; and
the cover board layer is provided with a composite film layer at a position corresponding to the bending region and a hardened thin film at a position corresponding to the non-bending region;
wherein the composite film layer includes a stress buffer layer and a water blocking layer located on a surface of the stress buffer layer.

2. The flexible polarizing cover board according to claim 1, wherein a thickness of the stress buffer layer is greater than a thickness of the water blocking layer.

3. The flexible polarizing cover board according to claim 1, wherein material of the stress buffer layer is an anti-bending transparent material.

4. The flexible polarizing cover board according to claim 1, wherein edges of the composite film layer extend beyond a boundary line between the bending region and the non-bending region to an interior of the non-bending region.

5. The flexible polarizing cover board according to claim 4, wherein on adjacent edges of the composite film layer and the hardened thin film, a junction edge of the composite film layer is provided with a plurality of openings, a junction edge of the hardened thin film is provided with a plurality of protrusions individually corresponding to the openings, and each of the protrusions is embedded in its corresponding opening.

6. The flexible polarizing cover board according to claim 1, wherein the bending region is disposed at a middle or one side of the flexible polarizing cover board.

7. The flexible polarizing cover board according to claim 1, wherein the polarizing layer includes a first polarizing layer including a liquid crystal layer, and a second polarizing layer including a polyvinyl alcohol film.

8. A manufacturing method of a flexible polarizing cover board, comprising:
a step 1 of manufacturing a liquid crystal layer and a polyvinyl alcohol film located on a surface of the liquid crystal layer to form a polarizing layer;
a step 2 of manufacturing a hardened thin film on a surface of a non-bending region of the polarizing layer; and
a step 3 of manufacturing a stress buffer layer and a water blocking layer located on a surface of the stress buffer layer, on a surface of a bending region of the polarizing layer.

9. A flexible display device, comprising:
a display panel;
a touch layer located above the display panel; and
a flexible polarizing cover board located above the touch layer;
wherein the flexible polarizing cover board includes a polarizing layer and a cover board layer configured to bond to each other;
the flexible polarizing cover board has a bending region and a non-bending region; and
the cover board layer is provided with a composite film layer at a position corresponding to the bending region and a hardened thin film at a position corresponding to the non-bending region;
wherein the composite film layer includes a stress buffer layer and a water blocking layer located on a surface of the stress buffer layer; and
the polarizing layer includes a first polarizing layer including a liquid crystal layer, and a second polarizing layer including a polyvinyl alcohol film.

10. The flexible display device according to claim 9, wherein a thickness of the first polarizing layer is one-fourth of a light-emitting wavelength of the display panel.
